(19) United States
(12) Patent Application Publication
(10) Pub. No.: US 2026/0297770 A1
(43) Pub. Date: Oct. 1, 2026

(54) COPPER-PHOSPHORUS/COBALT FOAM COMPOSITE CATALYST AND PREPARATION METHOD THEREOF

(71) Applicant: SOUTHWEST PETROLEUM UNIVERSITY, Chengdu (CN)

(72) Inventors: Ying ZHOU, Chengdu (CN); Yu BAI, Chengdu (CN); Heng GUO, Chengdu (CN); Qinghua LIU, Chengdu (CN); Fengying ZHANG, Chengdu (CN); Ruiyang ZHANG, Chengdu (CN)

(73) Assignee: SOUTHWEST PETROLEUM UNIVERSITY, Chengdu (CN)

(21) Appl. No.: 19/298,388

(22) Filed: Aug. 13, 2025

Related U.S. Application Data
(63) Continuation-in-part of application No. PCT/CN2025/098443, filed on May 30, 2025.

(30) Foreign Application Priority Data
Mar. 26, 2025 (CN) 202510364473.8

(51) Int. Cl. C25B 11/042; C01C 1/04

(52) U.S. Cl. CPC C25B 11/042; C01C 1/04

(57) ABSTRACT

Provided is a copper-phosphorus/cobalt foam composite catalyst and its preparation method, the method including: S1: obtaining a cobalt foam and pretreating the cobalt foam; S2: obtaining a cobalt oxyhydroxide precursor with a double-layer hydroxide structure by performing alkali treatment on pretreated cobalt foam; S3: obtaining a copper/cobalt foam precursor by preparing copper-plating electrolyte and subjecting the cobalt oxyhydroxide precursor to electrodeposition in the copper-plating electrolyte; and S4: obtaining the copper-phosphorus/cobalt foam composite catalyst by performing phosphating annealing treatment on the copper/cobalt foam precursor.

### CROSS-REFERENCE TO RELATED APPLICATIONS

This application is a continuation-in-part of International Application No. PCT/CN2025/098443, filed on May 30, 2025, which claims the priority of Chinese Patent Application No. 2025103644738, filed on Mar. 26, 2025, the entire contents of each of which are incorporated herein by reference.

### TECHNICAL FIELD

The present disclosure relates to the technical field of catalysts, and in particular, to a copper-phosphorus/cobalt foam composite catalyst and a preparation method thereof.

### BACKGROUND

With the global energy structure transitioning to cleaner and lower carbonization, green ammonia synthesis technology, as an important chemical production process, has received widespread attention. Ammonia, not only a key raw material for fertilizer production, is also regarded as a potential carrier of clean energy. The traditional Haber-Bosch method is currently the main method for industrial ammonia synthesis, but it relies on fossil fuels as a hydrogen source and requires harsh reaction conditions (high temperature and pressure), accompanied by a large amount of carbon dioxide emissions, which is not conducive to sustainable development. Therefore, the development of green and low-carbon ammonia synthesis technologies has become a hotspot of current research.

Electrochemical ammonia synthesis is a promising green pathway for ammonia production, employing electrochemical reactions to convert nitrogen or nitrate into ammonia. When nitrogen is used as a nitrogen source, the ammonia yield is extremely low (about 0.1-100 μg h⁻¹ mg cat⁻¹) due to limitations such as the poor solubility of nitrogen in water, the difficulty of activating the strong NEN bond energy, and the competing hydrogen evolution reaction. Therefore, the technology remains unavailable for large-scale production of ammonia. When nitrate is used as a nitrogen source, it not only enables the resourceful use of nitrate in wastewater, but also reduces reliance on fossil fuels and lowers carbon emissions. However, the core challenge of nitrate reduction electrochemical reactions lies in the development of efficient and stable catalysts.

Currently, precious metal catalysts such as platinum, palladium, and ruthenium show high catalytic activity, but their high cost and scarcity limit further large-scale application. In addition, copper metal with single crystal face is a relatively high-performance catalyst but suffers from stability issues due to the strong adsorption of nitrogen-containing intermediates, which are prone to rapid deactivation during the reduction process. Moreover, at low overpotentials, weak adsorption of hydrogen radicals to Cu limits the hydrogenation rate, and at high overpotentials, the predominance of the hydrogen evolution reaction results in insufficient conversion of ammonia products.

Cobalt-based materials are considered as a promising non-precious metal catalyst candidate due to their abundant natural resources, low cost, and good performance. However, pure cobalt materials are not active and selective enough in the nitrate reduction reaction for ammonia synthesis, failing to meet practical requirements.

Therefore, it is desirable to provide a copper-phosphorus/cobalt foam composite catalyst and a preparation method thereof. By performing a plurality of treatments on cobalt foam, the copper-phosphorus/cobalt foam composite catalyst with excellent electrochemical activity and stability is obtained.

### SUMMARY

In response to the above problems, one or more embodiments of the present disclosure provide a preparation method for a copper-phosphorus/cobalt foam composite catalyst, comprising: S1: obtaining cobalt foam and pretreating the cobalt foam; S2: obtaining a cobalt oxyhydroxide precursor with a double-layer hydroxide structure by performing alkali treatment on pretreated cobalt foam; S3: obtaining a copper/cobalt foam precursor by preparing a copper-plating electrolyte and subjecting the cobalt oxyhydroxide precursor to electrodeposition in the copper-plating electrolyte; wherein the electrodeposition is performed at a constant voltage of −2 to −2.5 V vs. RHE for 100-600 s; and S4: obtaining the copper-phosphorus/cobalt foam composite catalyst by performing phosphating annealing treatment on the copper/cobalt foam precursor; wherein the performing phosphating annealing treatment on the copper/cobalt foam precursor includes: placing the copper/cobalt foam precursor and sodium hypophosphite powder in a tube furnace, heating to 400° C. at a rate of 1-3° C./min in an argon atmosphere, and holding for 20-30 min; wherein the cobalt foam is used as a substrate of the copper-phosphorus/cobalt foam composite catalyst, the substrate is covered with a coating layer including phosphorus nanoparticles and copper nanoparticles, and the phosphorus nanoparticles and the copper nanoparticles are evenly distributed on a surface of the substrate in a lamellar nanostructure formed by nanoparticle accumulation, and a surface of the copper-phosphorus/cobalt foam composite catalyst exhibits an irregular stacked matrix morphology.

One or more embodiments of the present disclosure further provide a copper-phosphorus/cobalt foam composite catalyst, which is prepared by the preparation method for the copper-phosphorus/cobalt foam composite catalyst, and its use in the nitrate reduction reaction for ammonia synthesis.

### BRIEF DESCRIPTION OF THE DRAWINGS

In order to more clearly illustrate the technical solutions in the embodiments of the present disclosure or prior art, the accompanying drawings that need to be used in the description of the embodiments or prior art will be briefly described below, and it will be obvious that the accompanying drawings in the following description are only some of the embodiments of this disclosure, and for the person of ordinary skill in the field, in the premise of not paying creative labor, other drawings may be obtained based on these drawings.

FIG. 1 is a flowchart of a preparation method for a copper-phosphorus/cobalt foam composite catalyst according to some embodiments of the present disclosure;

FIG. 2 is a surface scanning electron microscope (SEM) image of a copper-phosphorus/cobalt foam composite catalyst in Example 1;

FIG. 3 is a transmission electron microscope (TEM) image of the copper-phosphorus/cobalt foam composite catalyst in Example 1;

FIG. 4 is an X-ray Diffraction (XRD) pattern of the copper-phosphorus/cobalt foam composite catalyst in Example 1 before and after electrochemical ammonia synthesis reaction;

FIG. 5 shows an ammonia production activity and Faraday efficiency of the copper-phosphorus/cobalt foam composite catalyst in Example 1;

FIG. 6 shows a long-term electrolytic stability test of the copper-phosphorus/cobalt foam composite catalyst in Example 1 at −0.3 V vs. RHE;

FIG. 7 shows a change in a product content over time during nitrate reduction using the copper-phosphorus/cobalt foam composite catalyst in Example 1;

FIG. 8 shows a cyclability test of the copper-phosphorus/cobalt foam composite catalyst in Example 1 at −0.3 V vs. RHE.

### DETAILED DESCRIPTION

The present disclosure is further described below in conjunction with the accompanying drawings and examples. It should be noted that the embodiments and technical features in the embodiments of this present disclosure may be combined without conflict. It should be noted that, unless otherwise indicated, all technical and scientific terms used in the present disclosure have the same meanings as commonly understood by one of ordinary skill in the art to which the present disclosure belongs. This disclosure discloses that the use of the words “comprising” or “includes” and similar words means that the components or objects appearing in front of the words encompass the components or objects appearing after the words and their equivalents, and do not exclude other components or objects.

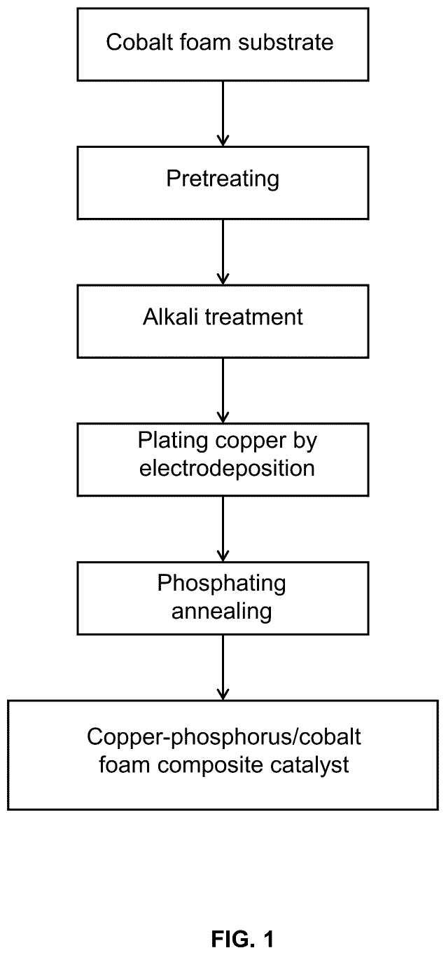

FIG. 1 is a flowchart of a preparation method for a copper-phosphorus/cobalt foam composite catalyst according to some embodiments of the present disclosure.

In some embodiments, as shown in FIG. 1, the preparation method for the copper-phosphorus/cobalt foam composite catalyst comprises the following steps.
S1: obtaining cobalt foam and pretreating the cobalt foam.

In some embodiments, the cobalt foam may also be referred to as a cobalt foam substrate.

The cobalt foam is a cobalt-based material having a porous foam-like structure. In some embodiments, the cobalt foam may be obtained by any feasible method, such as templating or powder metallurgy, etc. The pretreating may be a treatment capable of cleaning the surface of the cobalt foam, such as ultrasonic cleaning or degreasing.

In some embodiments, the pretreating includes performing ultrasonic cleaning treatment with a hydrochloric acid solution, anhydrous ethanol, deionized water, etc., in sequence.

In some embodiments, a concentration of the hydrochloric acid solution may be pre-set based on historical experience. For example, the concentration of the hydrochloric acid solution is within a range of may be 0.5-1 mol/L. For another example, the concentration of the hydrochloric acid solution is within a range of 0.6-0.8 mol/L. For another example, the concentration of the hydrochloric acid solution is 0.7 mol/L.

In some embodiments, a duration of the ultrasonic cleaning treatment may be pre-set based on historical experience. For example, the duration of the ultrasonic cleaning treatment is 15-20 min. For another example, the duration of the ultrasonic cleaning treatment is 17-20 min.

In some embodiments, the ultrasonic cleaning treatment may be performed by a cleaning device following ultrasonic cleaning parameters. The ultrasonic cleaning parameters refer to parameters associated with the ultrasonic cleaning treatment. In some embodiments, the ultrasonic cleaning parameters include a cleaning intensity and a cleaning duration of each cleaning stage of a plurality of cleaning stages, or the like. The cleaning intensity may be represented by the amount of the discharged water during the cleaning, with the higher the amount of discharged water, the higher the cleaning intensity. The ultrasonic cleaning parameters may be pre-set based on historical experience.

In some embodiments, the processor may acquire a cobalt foam image via an image acquisition device and determine a contamination degree of the cobalt foam based on the cobalt foam image. The processor may also determine the ultrasonic cleaning parameters based on the contamination degree.

The processor may be used to process data during the preparation of the copper-phosphorus/cobalt foam composite catalyst. In some embodiments, the processor may be communicatively connected to an annealing device, a cleaning device, an image acquisition device, or the like. The annealing device refers to a device for performing a phosphating annealing treatment, such as at least one of a tube furnace, a mesh belt furnace, an atmosphere protection furnace, etc.

In some embodiments, the annealing device is provided with a holding chamber for holding the copper/cobalt foam precursor during the phosphating annealing treatment.

In some embodiments, the processor may include a central processing unit (CPU), an application-specific integrated circuit (ASIC), an application-specific instruction set processor (ASIP), a graphics processing unit (GPU), a physics processing unit (PPU), a digital signal processor (DSP), a controller, a microprocessor, etc., or any combination thereof.

In some embodiments, the processor may be communicatively connected to a storage device. The storage device may be used to store data, instructions, and/or any other information. For example, the storage device may store historical records of preparing the copper-phosphorus/cobalt foam composite catalyst, etc.

In some embodiments, the storage device may include a mass memory, a removable memory, etc., or any combination thereof.

The image acquisition device refers to a device that acquires an image of the cobalt foam. In some embodiments, the image acquisition device includes an industrial camera, etc. The image acquisition device may be communicatively connected to the processor.

The cobalt foam image refers to image data of a cobalt foam surface.

The contamination degree is used to characterize the degree to which the cobalt foam surface is contaminated by impurities such as dust and oil. In some embodiments, the contamination degree may be characterized by a ratio of an area of the cobalt foam surface covered by impurities to the total area of the cobalt foam surface, for example, if a ratio of the area of the cobalt foam surface covered by impurities to the total area of the cobalt foam surface is 20%, then the contamination degree is 20%.

In some embodiments, the processor may use an image recognition model to recognize one or more areas of the cobalt foam surface in the cobalt foam image that are covered by impurities and output the contamination degree.

In some embodiments, the image recognition model is a machine learning model, e.g., one or any combination of YOLOv5, a Faster Region-based Convolutional Neural Network (Faster R-CNN) model, or another customized model structure, or the like.

In some embodiments, the plurality of cleaning stages may be pre-set based on historical experience, with one cleaning stage corresponding to one solution. For example, in the ultrasonic cleaning parameters, a first cleaning stage uses the hydrochloric acid solution, a second cleaning stage uses the anhydrous ethanol, a third cleaning stage uses the deionized water, or the like.

In some embodiments, the processor may determine the ultrasonic cleaning parameters in a plurality of ways based on the contamination degree. For example, the cleaning intensity and the cleaning duration for each cleaning stage of the ultrasonic cleaning parameters are positively correlated to the contamination degree.

In some embodiments, the processor may also construct a cleaning feature vector based on the contamination degree, an appearance parameter of the cobalt foam, and cleaning solution data, retrieve in a first vector library based on the cleaning feature vector, and set reference ultrasonic cleaning parameters corresponding to a reference feature vector that satisfies a first matching condition as current ultrasonic cleaning parameters. The first matching condition includes that a similarity between the reference feature vector and the cleaning feature vector is maximum. The vector similarity is negatively correlated with the vector distance, which includes Euclidean distance, or the like.

The appearance parameter refers to a parameter used to describe the appearance of the cobalt foam. In some embodiments, the appearance parameter includes the size and shape of the cobalt foam, etc. In some embodiments, the processor may extract the appearance parameter from the cobalt foam image via the image recognition model.

The cleaning solution data refers to data related to a solution used in the cleaning stage. In some embodiments, the cleaning solution data includes a concentration of the solution used in one or more cleaning stages, or the like, for example, the concentration of the hydrochloric acid solution. The cleaning solution data may be pre-set based on the concentration of the solution actually used in the cleaning stage.

In some embodiments, the first vector library may be pre-set based on historical experience, including a plurality of reference feature vectors and a reference ultrasonic cleaning parameter corresponding to each reference feature vector. The reference feature vectors refer to feature vectors constructed based on historical contamination degree, historical appearance parameter, and historical cleaning solution data.

Exemplarily, the processor may construct a reference feature vector based on the historical contamination degree, the historical appearance parameter, and the historical cleaning solution data corresponding to the successful cleaning record in the historical record and use the historical ultrasonic cleaning parameters corresponding to the reference feature vector as the reference ultrasonic cleaning parameters corresponding to the reference feature vector. The successful cleaning record refers to a historical record that the cobalt foam after cleaning meets cleaning requirements. The cleaning requirement includes the contamination degree being less than a contamination threshold, etc. The contamination threshold may be pre-set based on historical experience.

In some embodiments, by capturing an image of the cobalt foam surface and obtaining the contamination degree on the cobalt foam surface by using an industrial camera, a scientific basis may be provided for determining the appropriate ultrasonic cleaning parameters. Flexibly adjusting the cleaning intensity, the cleaning duration, etc., according to the specific contamination degree of the cobalt foam not only ensures thorough removal of the contaminants, but also avoids the waste of resources caused by excessive cleaning.

It should be noted that the purpose of the pretreating is to remove impurities such as oxides and organics on the cobalt foam surface, and in addition to the pretreating method of the above embodiment, other pretreating methods capable of realizing this purpose may also be applicable to this disclosure.
S2: obtaining a cobalt oxyhydroxide precursor with a double-layer hydroxide structure by performing alkali treatment on pretreated cobalt foam.

The double-layer hydroxide structure is a layered hydroxide structure formed by the coordination of cobalt cations with hydroxyl groups or oxygen, with two layers of hydroxo groups (or water molecules) sandwiched between the cobalt-oxygen layers.

In some embodiments, the performing alkali treatment on the pretreated cobalt foam includes placing the pretreated cobalt foam in an alkaline solution (e.g., a sodium hydroxide solution, etc.) and holding at a reaction temperature of 75-85° C. for 12-14 h. The reaction temperature and holding time may be pre-set based on historical experience.

In some embodiments, a concentration of the sodium hydroxide solution may be pre-set based on historical experience. For example, the concentration of the sodium hydroxide solution is within a range of 1-4 mol/L. For another example, the concentration of the sodium hydroxide solution is within a range of 2-4 mol/L. For another example, the concentration of the sodium hydroxide solution is 3 mol/L.

Exemplarily, the cobalt oxyhydroxide precursor with the double-layer hydroxide structure is obtained by placing the pretreated cobalt foam in a sodium hydroxide solution with a concentration of 3 mol/L and holding at 76° C. for 12 h.

It should be noted that the purpose of the alkali treatment is to hydroxylate the cobalt foam so that the cobalt foam forms the cobalt oxyhydroxide precursor with the double-layer hydroxide structure, and in addition to the alkali treatment method of the above embodiment, the alkali treatment methods, formed by varying the type (e.g., potassium hydroxide solution, etc.) and concentration of the alkaline solution, and the temperature and duration of the alkali treatment, can also be applied to the present disclosure as long as it is capable of forming the cobalt foam into the cobalt oxyhydroxide precursor with the double-layer hydroxide structure.
S3: obtaining a copper/cobalt foam precursor by preparing a copper-plating electrolyte and subjecting the cobalt oxyhydroxide precursor to electrodeposition in the copper-plating electrolyte.

In some embodiments, preparing the copper-plating electrolyte and subjecting the cobalt oxyhydroxide precursor to electrodeposition in the copper-plating electrolyte may also be referred to as electrodeposited copper plating.

The copper-plating electrolyte is a solution for depositing a copper layer on the surface of the cobalt oxyhydroxide precursor by electrolysis. In some embodiments, the copper-plating electrolyte may be prepared by dissolving copper sulfate in deionized water.

The electrodeposition is a process of depositing a metal or an alloy layer on the surface of an electrically conductive substrate through an electrochemical reaction.

In some embodiments, an electrolyte of the copper-plating electrolyte is at least one of copper chloride, copper sulfate, and copper nitrate.

In some embodiments, a concentration of the copper-plating electrolyte may be pre-set based on historical experience. For example, the concentration of the copper-plating electrolyte is within a range of 1-4 mol/L. For another example, the concentration of the copper-plating electrolyte is within a range of 2-4 mol/L. For another example, the concentration of the copper-plating electrolyte is 3 mol/L.

In some embodiments, a potential value and a deposition time of the electrodeposition when the cobalt oxyhydroxide precursor is placed in the copper-plating electrolyte may be pre-set based on historical experience. For example, the electrodeposition is performed at a constant voltage (keeping the voltage between the electrodes constant) of −2 to −2.5 V vs. RHE (the voltage relative to a potential value of reversible hydrogen electrode (RHE) is −2 to −2.5 V) for 100-600 s.

It should be noted that the copper-plating electrolyte and electrodeposition parameters of the above embodiments are only preferred parameters of the present disclosure, and other copper-plating electrolytes and electrodeposition parameters that are also capable of realizing copper plating by electrodeposition may also be suitable for the present disclosure.
S4: obtaining the copper-phosphorus/cobalt foam composite catalyst by performing phosphating annealing treatment on the copper/cobalt foam precursor.

In some embodiments, the performing phosphating annealing treatment on the copper/cobalt foam precursor includes placing the copper/cobalt foam precursor with the sodium hypophosphite powder in an annealing device (e.g., the tube furnace, etc.) and heating and holding in an inert atmosphere (e.g., an argon atmosphere, etc.). A heating rate, a target temperature, and a holding time may be pre-set based on historical experience. For example, the heating rate is within a range of 1-3° C./min, the target temperature is 400° C., and the holding time is within a range of 20-30 min.

It should be noted that the phosphating annealing parameters of the above embodiments are only the preferred parameters of the present disclosure, and other parameters that are also capable of realizing the phosphating annealing treatment may be suitable for the present disclosure.

In the present disclosure, for the preparation method of the copper-phosphorus/cobalt foam composite catalyst, the cobalt foam is used as a substrate, and then the cobalt foam substrate is covered with a coating layer including phosphorus nanoparticles and copper nanoparticles, to retain the macroporous framework structure of the cobalt foam substrate, the phosphorus nanoparticles and the copper nanoparticles are evenly distributed on a surface of the cobalt foam substrate in a lamellar structure formed by nanoparticle accumulation, and a surface of the copper-phosphorus/cobalt foam composite catalyst exhibits an irregular stacked matrix morphology.

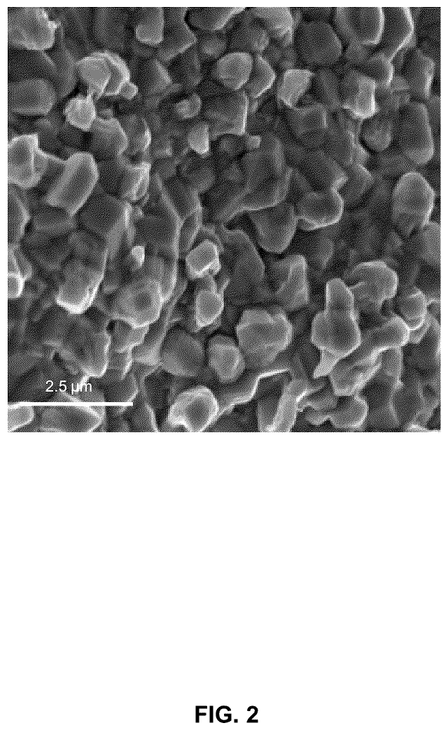

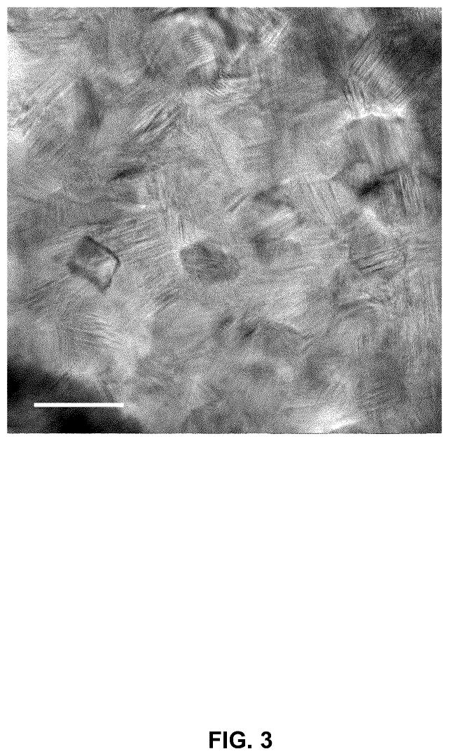

The evenly distribution is the coverage of particles on the substrate surface without any aggregation and any blank area. The irregular stacked matrix morphology is a composite structure formed by the particles stacked in a disordered or random manner. For more details on the surface morphology of the copper-phosphorus/cobalt foam composite catalyst may be found in FIG. 2 and FIG. 3 and their related descriptions.

In some embodiments, the annealing device may operate following a target temperature control curve.

In some embodiments, the processor may generate a plurality of candidate temperature control curves based on a starting temperature and a target temperature for the phosphide annealing treatment, determine a plurality of predicted quality data based on composition data of the copper/cobalt foam precursor, the plurality of candidate temperature control curves, and a device's temperature control accuracy. The processor may also determine the target temperature control curve based on the plurality of predicted quality data and send the target temperature control curve to a temperature controller within the annealing device to control an operating temperature of the annealing device.

The starting temperature refers to a temperature of the copper/cobalt foam precursor at the beginning of the phosphate annealing treatment. The target temperature refers to a temperature that the copper/cobalt foam precursor needs to reach during the phosphate annealing treatment. The target temperature may be determined based on production needs, such as 400° C.

In some embodiments, the processor may obtain the starting temperature at the beginning of the phosphating annealing treatment by measuring the copper/cobalt foam precursor using a temperature monitoring device. The temperature monitoring device includes a thermocouple temperature sensor or an infrared thermometer, etc.

The candidate temperature control curve refers to a temperature control curve to be determined. The target temperature control curve refers to a determined temperature control curve. The temperature control curve refers to a curve used to guide the annealing device in controlling the temperature of the phosphating annealing treatment. In some embodiments, the horizontal coordinate of the temperature control curve may be time, the vertical coordinate may be temperature, and the slope may be the heating rate.

In some embodiments, the processor may obtain the candidate temperature control curve in a plurality of ways. For example, the processor may use a plurality of historical temperature control curves with the same starting temperature and a same target temperature as a current starting temperature and a current target temperature from the history record are as the plurality of candidate temperature control curves.

In some embodiments, the processor may also randomly generate the plurality of candidate temperature control curves based on the starting temperature and the target temperature. For example, the processor may randomly divide the plurality of stages between the starting temperature and the target temperature, and randomly generate a heating rate for each stage, generate a curve for each stage based on a starting point, an ending point, and the heating rate for each stage, and connect curves of the plurality of stages to obtain the candidate temperature control curve.

The composition data refers to data related to the composition of the copper/cobalt foam precursor. In some embodiments, the composition data includes constituent components of the copper/cobalt foam precursor and the content or content percentage of each constituent component.

In some embodiments, the composition data of the copper/cobalt foam precursor may be obtained by a chemical analysis method. In some embodiments, the chemical analysis method may include one or more of Inductively Coupled Plasma-Optical Emission Spectroscopy (ICP-OES) and Energy Dispersive X-ray Spectroscopy (EDX).

The device's temperature control accuracy refers to an accuracy degree with which the annealing device maintains at a specific temperature. In some embodiments, the device's temperature control accuracy may be expressed by a maximum difference (e.g., 2° C.) in up and down temperature fluctuations when the annealing device maintains at a specific temperature. The smaller the difference, the higher the device's temperature control accuracy. For example, if an actual temperature in the annealing furnace fluctuates between 399° C. and 401° C. when the annealing furnace maintains at a specific temperature (e.g., 400° C.), the device's temperature control accuracy of the annealing furnace is 2° C. The device's temperature control accuracy may be obtained from labels such as the nameplate of the annealing device.

The predicted quality data refers to a predicted value of the quality data of the copper-phosphorus/cobalt foam composite catalyst obtained by performing phosphating annealing treatment on the copper/cobalt foam precursor according to the candidate temperature control curve. The quality data refers to data related to the quality of the obtained copper-phosphorus/cobalt foam composite catalyst.

In some embodiments, the quality data may be represented by a numerical value. The processor may obtain the quality data by conducting a comprehensive evaluation based on indicators such as an ammonia production rate, Faraday efficiency, structural stability, and product purity (a mass percentage of the copper-phosphorus/cobalt foam composite catalyst in the final product).

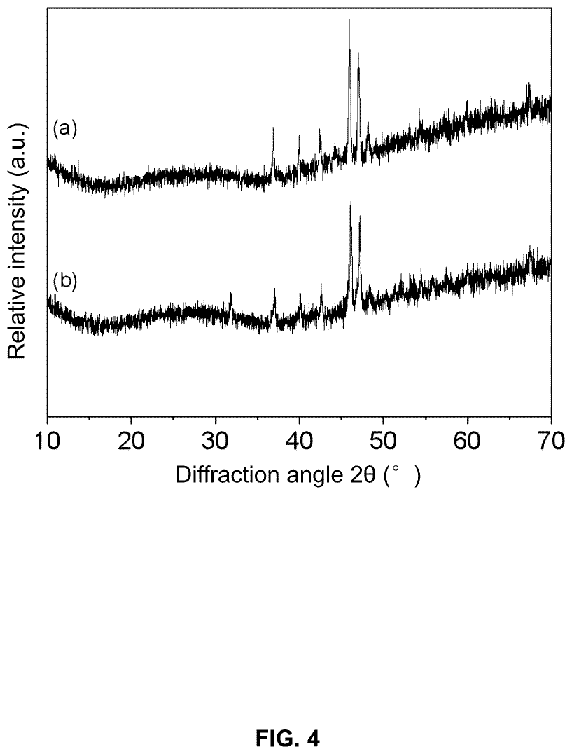

In some embodiments, the indicators such as the ammonia production rate, the Faraday efficiency, the structural stability, and the product purity may be measured and calculated by measuring devices such as a scanning electron microscope, a transmission electron microscope, and an X-ray diffractometer. More details may be found in FIG. 4-FIG. 8 and their related descriptions for this section.

In some embodiments, the quality data may be positively correlated with the ammonia production rate, the Faraday efficiency, the structural stability, and the product purity.

In some embodiments, the processor may obtain the predicted quality data corresponding to each candidate temperature control curve through a quality assessment model based on the composition data of the copper/cobalt foam precursor, the plurality of candidate temperature control curves, and the device's temperature control accuracy.

In some embodiments, the quality assessment model may be a deep learning model, such as anyone or a combination of Convolutional Neural Network (CNN), Recurrent Neural Network (RNN), Long Short-Term Memory (LSTM), or other customized model structures.

In some embodiments, the processor may obtain the quality assessment model by training a plurality of first training samples with first labels by a gradient descent method. The first training sample includes sample composition data, a sample temperature control curve, and a sample device's temperature control accuracy. The first label corresponding to the first training sample includes actual quality data corresponding to the sample candidate temperature control curve.

In some embodiments, the processor may obtain the first training samples and the first labels based on the history record. For example, the processor may take the historical composition data, the historical temperature control curve, and the historical device's temperature control accuracy in the historical record as the first training sample and take the actual quality data corresponding to the historical temperature control curve in the historical record as the first label corresponding to the first training sample. The actual quality data may be determined by manual labeling.

In some embodiments, the training process of the quality assessment model includes: inputting the first training samples into an initial quality assessment model, constructing a loss function based on the output of the initial quality assessment model and the first labels, iteratively updating parameters of the initial quality assessment model based on the loss function until a preset training condition is met, completing the training, and obtaining a trained quality assessment model. The preset training condition may include the loss function converging or a training cycle reaching a threshold, etc. In some embodiments, the input of the quality assessment model may also include preset gas parameters.

The preset gas parameters refer to gas parameters that is predetermined. The gas parameters refer to data related to a protective gas used in the phosphating annealing treatment. The protective gas refers to a gas used to isolate oxygen and maintain the phosphating reaction environment, etc., during the phosphating annealing treatment, such as inert gas.

In some embodiments, the gas parameters include a rate at which the protective gas is input into the holding chamber of the annealing device via a gas input port.

In some embodiments, if the input of the quality assessment model also includes the preset gas parameters, the first training sample also includes the sample preset gas parameters.

In some embodiments, the processor may also determine candidate gas parameters based on the composition data, the gas type, the starting temperature, and the target temperature, and determine gas parameters based on the candidate gas parameters.

The gas type refers to a type of protective gas. In some embodiments, the gas type may include argon or nitrogen, etc.

The candidate gas parameters refer to the gas parameters to be determined.

In some embodiments, the processor may construct an annealing feature vector based on the composition data, gas type, starting temperature, and target temperature, retrieve a reference annealing feature vector that satisfies a second matching condition with the annealing feature vector in the second vector library, and take reference gas parameters corresponding to the reference annealing feature vector as the candidate gas parameters. The second matching condition may include a vector similarity greater than a similarity threshold, which may be pre-set based on historical experience.

In some embodiments, the second vector library may be pre-set based on historical data, including a plurality of reference annealing feature vectors and reference gas parameters corresponding to each of the reference annealing feature vectors. For example, the processor may screen a plurality of excellent phosphating annealing processes in the historical record, construct the plurality of reference annealing feature vectors based on the composition data, the gas types, the starting temperatures, and target temperatures corresponding to the plurality of excellent phosphating annealing processes, and take the gas parameters corresponding to the plurality of excellent phosphating annealing processes as the reference gas parameters corresponding to the plurality of reference annealing feature vectors. The excellent phosphide annealing process may be a process of obtaining a qualified copper-phosphorus/cobalt foam composite catalyst after the phosphide annealing treatment. It may be determined whether the obtained copper-phosphorus/cobalt foam composite catalyst is qualified by manual labeling.

In some embodiments, the processor may input the composition data, the plurality of candidate temperature control curves, the device's temperature control accuracy, and the plurality of candidate gas parameters into the quality assessment model, and the quality assessment model outputs the predicted quality data corresponding to each set of the candidate temperature curve and the candidate gas parameters.

In some embodiments, the processor may determine a candidate temperature control curve with the highest predicted quality data as a target temperature control curve, and the candidate gas parameters of the same group as that candidate temperature control curve as gas parameters.

In some embodiments, after determining the gas parameters, the processor may send the gas parameters to a flow controller. The flow controller controls an input rate of the protective gas during the phosphate annealing treatment based on the gas parameters.

The flow controller refers to a device used to control the input of protective gas to the annealing device. In some embodiments, the flow controller includes a Mass Flow Controller (MFC) or a solenoid valve, etc.

In some embodiments, controlling the rate of protective gas input to the annealing device based on the gas parameters allows for a more precise optimization of the process conditions, resulting in the preparation of the high-quality copper-phosphorus/cobalt foam composite catalyst.

In some embodiments, the processor may determine the target temperature control curve based on the plurality of predicted quality data. For example, the processor determines the candidate temperature control curve corresponding to the highest predicted quality data among the plurality of predicted quality data as the target temperature control curve.

In some embodiments, after obtaining the target temperature control curve, the processor sends the target temperature control curve to a temperature controller within the annealing device to control the operating temperature of the annealing device. The temperature controller may control the operating temperature of the annealing device at different moments based on the heating rate in the target temperature control curve.

In some embodiments, the temperature controller includes a PID controller, or the like. The processor is communicatively connected to the temperature controller.

In some embodiments, by applying the quality assessment model, the predicted quality data corresponding to the candidate temperature control curve may be accurately predicted, which is conducive to determining the optimal target temperature control curve, thereby ensuring the temperature accuracy of the annealing treatment and improving the quality of the obtained copper-phosphorus/cobalt foam composite catalyst.

In some embodiments, the processor may determine zoning parameters based on the composition data of the copper/cobalt foam precursor, a gas input port location, an annealing device feature, output demand data, and a target placement location. The processor sends the zoning parameters to the annealing device to control the operating temperatures of a plurality of zones within the annealing device.

The zoning parameters refer to parameters that control the operating temperature of the plurality of zones within the annealing device. The zones are regions obtained by dividing the interior of the holding chamber within the annealing device. The temperatures of the different zones within the holding chamber may be different.

In some embodiments, the zoning parameters may include locations, areas, and zone target temperatures of the plurality of zones. The zone target temperature refers to a target temperature corresponding to the zone.

The target placement location refers to a location where the copper/cobalt foam precursor is placed in the holding chamber. In some embodiments, the target placement location may be pre-set.

The gas input port location refers to a location of the gas input port in use. In some embodiments, the annealing device may be provided with a plurality of gas input ports, and the processor may number the plurality of gas input ports to indicate gas input ports at different locations. The gas input port in use may be pre-set.

The annealing device feature is data related to the annealing device. In some embodiments, the annealing device feature may include a size and shape of the holding chamber. The processor may obtain the annealing device feature by reading the device nameplate parameters of the annealing device or by actually measuring the annealing device directly.

The output demand data refer to requirements for reaching the desired state or performance index of the target product (the copper-phosphorus/cobalt foam composite catalyst). For example, the output demand data may be a demand of the target product having a fully phosphatized center zone, a partially phosphatized edge zone, etc. The output demand data may be pre-set.

In some embodiments, the processor may use a zoning determination model to determine the zoning parameters based on the composition data, the gas input port location, the annealing device feature, the output demand data, and the target placement location, etc.

In some embodiments, the zoning determination model may be a deep learning model such as a Convolutional Neural Network (CNN), Recurrent Neural Network (RNN), Long Short-Term Memory (LSTM), etc.

In some embodiments, the processor may obtain the zoning determination model by training a plurality of second training samples with second labels via a gradient descent method, etc. The second training sample includes sample composition data, a sample gas input port location, a sample annealing device feature, sample output demand data, and a sample target placement location. The second label corresponding to the second training sample includes the actually used zoning parameters corresponding to the second training sample.

In some embodiments, the processor may obtain the second training samples and the second labels based on the history record and the experimental data. For example, the processor may use the historical composition data, the historical gas input port location, the historical annealing device feature, the historical output demand data, and the historical placement location in the historical record as the second training samples and obtain the second labels by conducting experiments based on the second training samples. The experimental process includes performing phosphating annealing treatment on the copper/cobalt foam precursor corresponding to the second training samples under a plurality of zoning parameters and using the zone parameters for which the obtained target product meets the sample output demand data as the second labels. The copper/cobalt foam precursor corresponding to the second training samples refers to the copper/cobalt foam precursor prepared under the conditions corresponding to the second training samples.

In some embodiments, a training process of the zone determination model is similar to the training process of the quality assessment model, which is not described herein.

In some embodiments, the input of the zoning determination model may also include a gas type. If the input of the zoning determination model also includes the gas type, the second training sample may include a sample gas type. The sample gas type is obtained based on historical data.

In some embodiments, after determining the zoning parameters, the processor may send the zoning parameters to the temperature controller, and the temperature controller may control, based on the target zone temperatures of the plurality of zones within the zoning parameters, temperatures of the plurality of zones of the annealing device to be consistent with the corresponding target zone temperatures during the phosphating annealing treatment.

In some embodiments, generating the zoning parameters using a machine learning model can speed up the determination of the zoning parameters and make the zoning decision more scientific and reasonable. Additionally, zoning control of the annealing device in the spatial dimension can improve the accuracy of the temperature control of the annealing device, and more finely control the heating process of various zones to ensure the quality of the product.

In some embodiments, after dividing the holding chamber of the annealing device into the plurality of zones, the processor may determine, based on the composition data, the plurality of candidate zone curves, the device's temperature control accuracy, the zoning parameters, and the gas input port location, the plurality of predicted quality data corresponding to the plurality of candidate zone curves. The processor determines the plurality of target zone curves based on the plurality of predicted quality data and sends the plurality of target zone curves to the temperature controller to control the operating temperature of the annealing device.

The candidate zone curve refers to a zone temperature control curve to be determined. The target zone curve refers to a determined zone temperature control curve.

In some embodiments, the zone temperature control curve refers to a curve used to guide the annealing device to control the temperature of the zones during the phosphating annealing treatment. A zone temperature control curve corresponds to a single zone.

In some embodiments, the candidate zone curves are obtained in a similar method to that of the candidate temperature control curves, and a zone may be set up with a plurality of candidate zone curves.

In some embodiments, the processor may determine the plurality of predicted quality data corresponding to the plurality of candidate zone curves through the quality assessment model based on the composition data, the plurality of candidate zone curves, the device's temperature control accuracy, the zoning parameters, and the gas input port location.

In some embodiments, the input of the quality assessment model includes the plurality of candidate zone curves, the zone parameters and the gas input port location. The sample temperature control curve in the first training sample may be replaced with a sample zone temperature control curve, with the addition of sample zone parameters, and a sample gas input port location.

In some embodiments, the input of the quality assessment model may be a plurality of candidate zone curves corresponding to a zone, and the processor may determine a target zone curve corresponding to the zone based on the predicted quality data of the plurality of candidate zone curves. For example, the processor may sort the plurality of predicted quality data and determine the candidate zone curve with the highest predicted quality data as the target zone curve. The target zone curve corresponding to each zone may be determined in the method described above.

In some embodiments, after determining the target zone curve for each zone, the processor may send the plurality of target zone curves to the temperature controller to control the temperatures of the different zones of the annealing device, respectively.

In some embodiments, by setting different temperature strategies for different zones, fine adjustment of the temperatures of each zone can be realized, avoiding energy waste caused by excessive heating or cooling, realizing effective utilization of resources. In addition, it also better controls the quality of the finally prepared copper-phosphorus/cobalt foam composite catalyst.

In some embodiments, during the phosphide annealing treatment, the processor may obtain crystal state data through a state monitoring device within the annealing device at a preset cycle and generate temperature adjustment parameters based on the crystal state data. The processor sends the temperature adjustment parameters to the annealing device to adjust the operating temperature of the annealing device.

In some embodiments, the preset cycle may be set in advance based on historical experience.

In some embodiments, the duration of the preset cycle may be related to the device's temperature control accuracy and the current heating rate. For example, the duration of the preset cycle may be positively correlated to the device's temperature control accuracy and negatively correlated to the current heating rate.

The current heating rate refers to a heating rate of the annealing device at the current moment. The processor may obtain the current heating rate of the annealing device through the target temperature control curve, etc.

In some embodiments of the present disclosure, the cycle is shortened when the device's temperature control accuracy is low, thereby allowing for more frequent state monitoring and temperature adjustment to ensure more precise temperature control. The cycle is shortened when the heating rate is fast to adjust the temperature promptly, avoiding quality problems due to excessively fast heating.

The state monitoring device refers to a device used to collect the crystal state data. In some embodiments, the state monitoring device may include an X-ray diffractometer, etc.

The crystal state data refers to data related to the structure or phase composition, etc., of the crystal. In some embodiments, the crystal state data may be represented by an XRD pattern, etc.

In some embodiments, the processor may determine, based on the crystal state data, a grain size and content of the target product, and generate temperature adjustment parameters based on the grain size and content of the target product.

In some embodiments, the processor may compare the XRD pattern with a standard diffraction PDF card of the target product to identify the phase composition of the intermediate product. The intermediate product may be a copper/cobalt foam precursor in the phosphide annealing treatment.

The standard diffraction PDF card refers to X-ray diffraction characteristic data corresponding to a known crystal, which may be used to provide a reference basis for phase identification and crystal structure analysis. In some embodiments, the standard diffraction PDF card corresponding to the crystal may include characteristic peak positions, peak intensities, crystal plane indices, etc., of the crystal. For example, the PDF card of the copper-phosphorus/cobalt foam complex may include characteristic peak positions, peak intensities, crystal plane indices, etc., of phases such as copper phosphides, cobalt phosphides, etc. The processor may obtain the standard diffraction PDF card of the target product from a third-party platform (e.g., the International Centre for Diffraction Data (ICDD) database, etc.).

Exemplarily, the processor may determine whether the characteristic peak positions indicating the target product in the XRD pattern are consistent with the characteristic peak positions of the standard diffraction PDF card of the target product. If the characteristic peak positions indicating the target product in the XRD pattern are consistent with the characteristic peak positions of the standard diffraction PDF card of the target product, the target product is present in the intermediate product.

In some embodiments, the processor may also calculate the grain size and content of the target product based on the XRD pattern and the standard diffraction PDF card of the target product by a predetermined formula (e.g., Scherrer formula, Simplified Rietveld method, etc.).

The temperature adjustment parameters refer to parameters that adjust the temperature or heating rate within the annealing device for the next preset cycle.

In some embodiments, the processor may generate the temperature adjustment parameters based on the grain size and content of the target product. For example, if the crystallization is incomplete, the processor may reduce the heating rate for the next preset cycle by a first predetermined magnitude. For example, if the formation of the target product is lagging, the processor may increase the temperature for the next preset cycle by a second predetermined magnitude.

In some embodiments, lagging in the formation of the target product may be that a content of the target product is less than a content threshold corresponding to the current preset cycle. The incomplete crystallization is that a grain size is less than a size threshold corresponding to the current preset cycle.

In some embodiments, the first predetermined magnitude and the second predetermined magnitude may be obtained in advance by predetermining.

In some embodiments, the processor may query the preset table based on the current preset cycle to obtain the size threshold and the content threshold corresponding to the current preset cycle.

In some embodiments, the preset table may be pre-set based on historical data, including size thresholds and content thresholds corresponding to a plurality of preset cycles. For example, for a single preset cycle, the processor may filter a plurality of excellent phosphating annealing processes in the historical record, determine an average of the grain sizes of the plurality of excellent phosphating annealing processes in the preset cycle as the size threshold corresponding to the preset cycle, and determine an average of the content as the content threshold corresponding to the preset cycle. The size threshold and the content threshold corresponding to each of the preset cycles may be determined by the method described above. More details about the excellent phosphating annealing process may be found in the above description.

In some embodiments of the present disclosure, by real-time monitoring of the crystal structure and the composition of the physical phase, it is possible to timely detect incomplete crystallization or lagging in the formation of the target product and to make adjustments to the heating rate or the temperature, which can realize the fine control of phosphating annealing treatment and improve the overall quality and performance of the obtained copper-phosphorus/cobalt foam composite catalyst.

The present disclosure also provides a copper-phosphorus/cobalt foam composite catalyst prepared using the above preparation method, and its use in nitrate reduction reaction for ammonia synthesis.

In some embodiments, when the copper-phosphorus/cobalt foam composite catalyst of the present disclosure is employed for the nitrate reduction reaction for ammonia synthesis, the copper-phosphorus/cobalt foam composite catalyst is used as the cathode electrode, the nitrate solution is used as an electrolyte, and the electrocatalytic reduction of nitrate for ammonia production is performed in a three-electrode electrochemical system.

In some embodiments, the nitrate solution is any one or more of a sodium nitrate solution, a potassium nitrate solution, a sodium nitrite solution, a potassium nitrite solution, etc. The concentration of the nitrate solution is within a range of 0.1-2 mol/L, and a solvent of the nitrate solution is a sodium hydroxide solution or a potassium hydroxide solution, etc., such that a pH of the nitrate solution is within a range of 13-14. The voltage for the electrocatalytic reduction of nitrate process is 0 to −0.3 V relative to a potential of the standard hydrogen electrode (i.e., RHE). In this embodiment, by employing an alkaline nitrate solution, it is possible to increase the conductivity of the solution and accelerate the rate of the electrolysis reaction.

It should be noted that the electrochemical ammonia synthesis parameters of the above embodiments are only the preferred parameters of the present disclosure, and other methods for electrochemical ammonia synthesis using catalysts with modified parameters may also be applied to the present disclosure.

### Example 1

A copper-phosphorus/cobalt foam composite catalyst was prepared by following contents.
(1) A cobalt foam (with a size of 2.0 cm×2.0 cm×0.2 cm) was obtained and pretreated. Specifically, the cobalt foam was ultrasonically cleaned in a dilute hydrochloric acid solution (at a concentration of 1 mol/L) and ethanol in sequence for 15 min to remove oil, oxides, etc., from the surface of the cobalt foam, and then ultrasonically cleaned in deionized water for 15 min, and rinsed and dried for later use.
(2) The pretreated cobalt foam was placed in 70 mL of a sodium hydroxide solution (at a concentration of 4 mol/L) and held in an oil bath at 80° C. for 12 h, and then cooled, cleaned, and dried to obtain a cobalt oxyhydroxide precursor with a double-layer hydroxide structure.
(3) A copper-plating electrolyte (a copper chloride solution at a concentration of 4 mol/L) was prepared as the electrodeposition solution, and the cobalt oxyhydroxide precursor served as a working electrode, and platinum sheets or graphite rods, etc., were used as a counter electrode. An electrochemical workstation was used to electrodeposit at a constant voltage of −2.0107 V vs. RHE for 300 s to obtain the copper/cobalt foam precursor.
(4) The copper/cobalt foam precursor was placed in a tube furnace, and 0.5 g of sodium hypophosphite powder and 0.1 g of sodium hypophosphite powder were placed in upstream and downstream of the tube furnace, respectively, and heated up to 400° C. at a heating rate of 2° C./min in an argon atmosphere, and held for 30 min to obtain the copper-phosphorus/cobalt foam composite catalyst.

### Example 2

Different from Example 1, the time of electrodeposition in step (3) of Example 2 was 100 s, 200 s, 400 s, 500 s, and 600 s, respectively.

### Example 3

Different from Example 1, the time of the phosphating annealing treatment (i.e., the holding time) in step (4) of Example 3 was 1 h, 1.5 h, and 2 h, respectively.

### Comparative Example 1

Different from Example 1, Comparative example 1 did not include steps (2)-(4), that is, the pretreated cobalt foam was used as the pure cobalt catalyst.

### Comparative Example 2

Different from Example 1, Comparative example 2 did not include step (3), that is, the cobalt oxyhydroxide precursor was not electrodeposited, and the cobalt oxyhydroxide precursor is directly subjected to the phosphating annealing treatment to obtain a phosphorus/cobalt foam catalyst.

### Comparative Example 3

Different from Example 1, Comparative example 3 did not include step (4), that is, the copper/cobalt foam precursor was not subjected to the phosphating annealing treatment and the copper/cobalt foam catalyst was obtained.

### Comparative Example 4

Different from Example 1, the substrate in step (1) of Comparative example 4 was copper foam, and in step (3), a cobalt plating electrolyte (a cobalt chloride solution at a concentration of 4 mol/L) was prepared for electrodeposition to obtain a cobalt-phosphorus/copper foam catalyst.

### Comparative Example 5

Different from Example 1, Comparative example 5 did not include step (2), that is, the pretreated cobalt foam was not subjected to alkali treatment and a copper-phosphorus/cobalt foam catalyst without alkali treatment was obtained.

### Test Example

In some embodiments, a scanning electron microscope (SEM), a transmission electron microscope (TEM), etc., were used to observe the morphology of the catalysts obtained in examples and comparative examples.

FIG. 2 is a surface SEM image of the copper-phosphorus/cobalt foam composite catalyst in Example 1. FIG. 3 is a TEM image of the copper-phosphorus/cobalt foam composite catalyst in Example 1.

In some embodiments, it can be seen from FIG. 2 and FIG. 3 that the surface of the copper-phosphorus/cobalt foam composite catalyst of the present disclosure exhibits an irregular stacked matrix morphology and polycrystalline properties, which is attributed to the fact that the copper-phosphorus/cobalt foam composite catalyst of the present disclosure is composed of copper nanoparticles and phosphorus nanoparticles with different orientations.

FIG. 4 is an XRD pattern of the copper-phosphorus/cobalt foam composite catalyst in Example 1 before and after electrochemical ammonia synthesis reaction.

In some embodiments, an X-ray diffractometer was used to observe the structures of the catalysts in examples and comparative examples. The XRD pattern of the copper-phosphorus/cobalt foam composite catalyst in Example 1 is shown in FIG. 4, where (a) is the XRD pattern of the copper-phosphorus/cobalt foam composite catalyst of the present disclosure before the electrochemical ammonia synthesis reaction, and (b) is the XRD pattern of the copper-phosphorus/cobalt foam composite catalyst of the present disclosure after 200 h of electrochemical ammonia synthesis reaction.

It can be seen from FIG. 4 that the positions of the main peaks do not shift before and after the reaction and the type of peaks does not decrease significantly, which indicates that the structure of the copper-phosphorus/cobalt foam composite catalyst of the present disclosure does not collapse after a continuous reaction, suggesting that the copper-phosphorus/cobalt foam composite catalyst of the present disclosure has good material structural stability. Combined with the SEM image and the TEM image, it suggests that the irregular stacked matrix can enhance the stability of the catalyst material.

In some embodiments, the catalysts in examples and comparative examples were used for nitrate reduction reaction for ammonia synthesis, and electrochemical measurements were conducted on a three-electrode electrochemical workstation in an electrolyte including 1 mol/L potassium hydroxide (KOH) and 0.1 mol/L potassium nitrate (KNO₃) at a voltage of −0.3 V vs. RHE. The Faradaic efficiency and ammonia production rate were analyzed, and the nitrate reduction reaction was carried out at a potential of −0.3 V vs. RHE for a preset time and multiple cycles to verify the stability of the copper-phosphorus/cobalt foam composite catalyst. The preset time and number of cycles are pre-set based on historical experience.

In some embodiments, the copper-phosphorus/cobalt foam composite catalyst of the present disclosure, a platinum sheet, and mercury/mercuric oxide ((Hg/HgO) are used as the working electrode, the counter electrode, and the reference electrode, respectively. Linear Sweep Voltammetry (LSV) tests were performed at a scan rate of 10 mV s⁻¹.

In some embodiments, the method for ammonia production is as follows: taking the reaction solution after constant potential nitric acid reduction at different potentials for 30 min, diluting the reaction solution by a predetermined multiple and then measuring the absorbance using the salicylic acid colorimetric method, and calculating the ammonia production rate based on the fitting formula of the standard curve. The standard curve refers to a concentration-absorbance relationship curve established by measuring the absorbance of an ammonia standard solution at a known concentration with the salicylic acid colorimetric method. The preset multiplier is pre-set based on historical experience.

In some embodiments, the processor calculates the Faraday efficiency according to the following equation (1):

$$F E = ( m 1 \times m 2 ) / ( Q \times F ) . \qquad ( 1 )$$

Where FE denotes the Faraday efficiency, m1 denotes a mole number of the product, m2 denotes a molar mass of the product, Q denotes a number of input charges, and F denotes an electronic charge. The product may be ammonia produced in the nitrate reduction reaction.

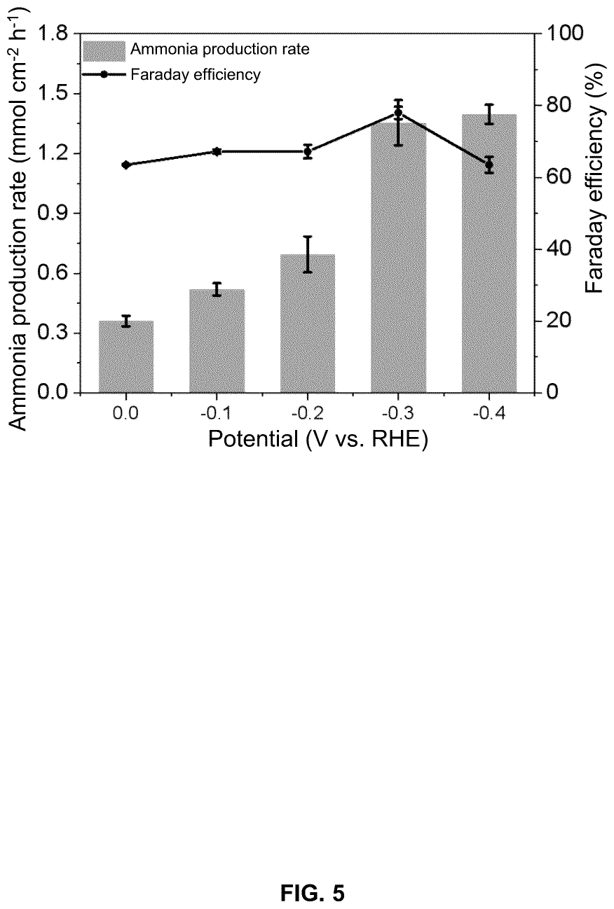

FIG. 5 shows an ammonia production activity and Faraday efficiency of the copper-phosphorus/cobalt foam composite catalyst in Example 1.

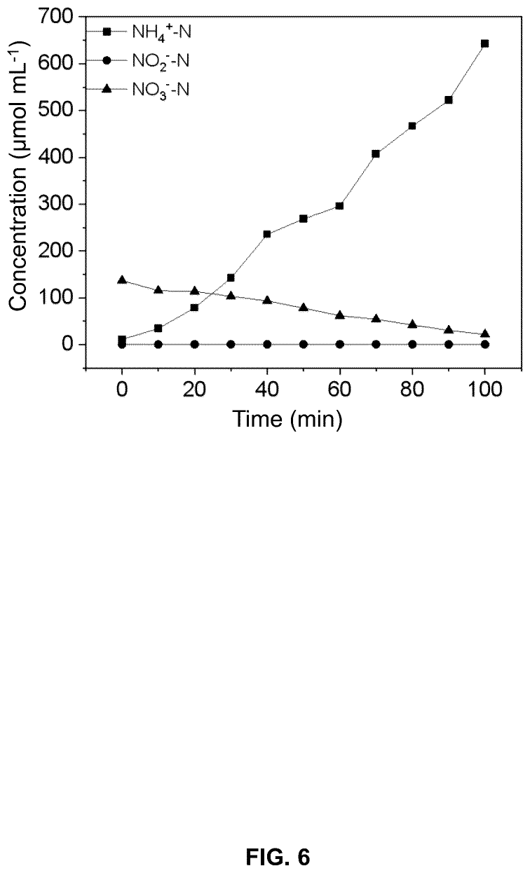

FIG. 6 shows a long-term electrolytic stability test of the copper-phosphorus/cobalt foam composite catalyst of Example 1 at −0.3 V vs. RHE.

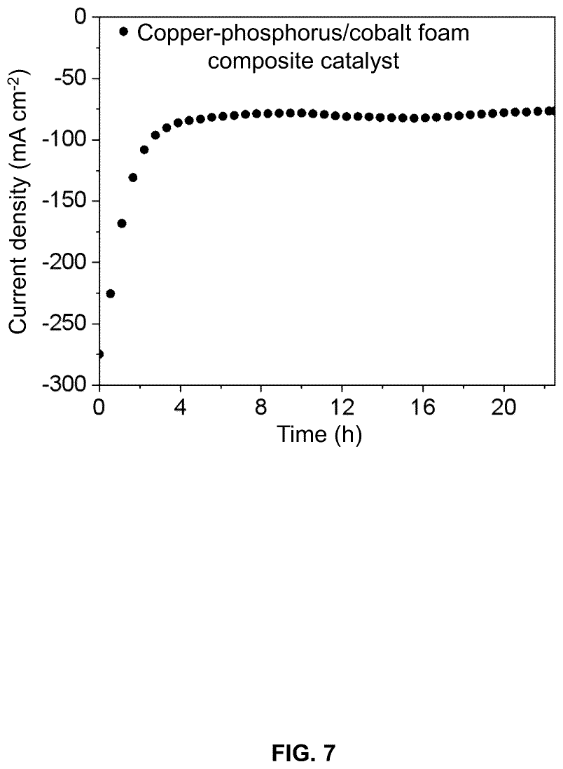

FIG. 7 shows a change in product content over time during nitrate reduction using the copper-phosphorus/cobalt foam composite catalyst in Example 1.

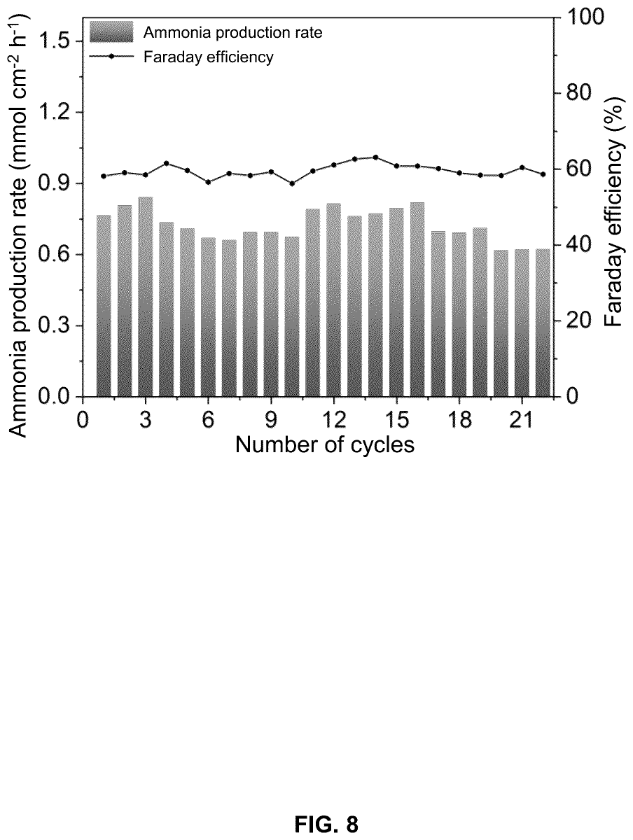

FIG. 8 shows a cyclability test of the copper-phosphorus/cobalt foam composite catalyst in Example 1 at −0.3 V vs. RHE.

Some test results are shown in Table 1 and FIG. 5-FIG. 8.

TABLE 1
Performance test results for examples and comparative examples

| | Reduction | Ammonia | | |
|---|---|---|---|---|
| | potential | production | Faraday | |
| | (V vs. | rate (mmol/ | efficiency | |
| Catalyst | RHE) | cm²/h) | (%) | Stability (200 h) |
| Example 1 | −0.3 | 1.4 ± 0.2 | 80.2 | No significant |
| | | | | aggregation |
| Comparative | −0.3 | 0.25 | 63.5 | Slight particle |
| Example 1 | | | | aggregation (>20%) |
| Comparative | −0.3 | 0.40 | 59.8 | Particle aggregation |
| Example 2 | | | | (>30%) |
| Comparative | −0.3 | 0.75 | 71.7 | Significant particle |
| Example 3 | | | | aggregation (>40%) |
| Comparative | −0.3 | 0.64 | 68.5 | Particle aggregation |
| Example 4 | | | | (>30%) |
| Comparative | −0.3 | 0.86 | 63.4 | Particle aggregation |
| Example 5 | | | | (>35%) |

As can be seen from FIG. 5, the Faraday efficiency of the copper-phosphorus/cobalt foam composite catalyst prepared in Example 1 ranges from 60% to about 80% as the potential varies from 0 V vs. RHE to −0.4 V vs, showing a trend of first increasing and then decreasing. The Faraday efficiency reaches the maximum of 80.2% at −0.3 V vs. RHE. The ammonia production rate shows a trend of gradually increasing and then stabilizing.

As can be seen from FIG. 6, the yields of ammonium ions and nitrite ions, and the consumption of nitrate ions of the copper-phosphorus/cobalt foam composite catalyst made in Example 1 at −0.3 V vs. RHE are presented. Specifically, the content of NO₃⁻-N gradually increases from 0.0135 min⁻¹ to 0.0398 min⁻¹ over time, which is attributed to the enhanced electron availability or the presence of the atomic hydrogen radicals at more negative potentials.

Nitrate removal rate tends to stabilize as the potential continues to increase, suggesting that the increase in removal rate cannot offset the decrease in energy utilization caused by the high voltage, and excess hydrogen tends to recombine into hydrogen gas. In addition, the generation of hydrogen bubbles impedes the reactive active site, preventing the adsorption of nitrate and other intermediates. The copper-phosphorus/cobalt foam composite catalyst of the present disclosure can exhibit high-efficiency catalytic activity at a low overpotential.

As can be seen from FIG. 7, there is no sharp change in current density during the long-term electrolysis of the copper-phosphorus/cobalt foam composite catalyst prepared in Example 1 in a strong alkali solution, which indicates that the copper-phosphorus/cobalt foam composite catalyst of the present disclosure has good stability.

As can be seen from FIG. 8, the production rate of ammonia via electrocatalytic nitrate reduction and the Faraday efficiency throughout the cycles do not show significant changes during 22 cycles of nitrate reduction at the potential of −0.3 V vs. RHE using the copper-phosphorus/cobalt foam composite catalyst prepared in Example 1, indicating that the copper-phosphorus/cobalt foam composite catalyst of the present disclosure has good stability.

As can be seen from Table 1, neither the pure cobalt catalyst (Comparative example 1) nor the phosphorus/cobalt foam catalyst without copper electrodeposition (Comparative example 2) can achieve the ammonia production rate and Faraday efficiency achievable in the present disclosure. Although the copper/cobalt foam catalyst without the annealing phosphating treatment (Comparative example 3) can reach the Faraday efficiency of about 71%, its stability is poor. The cobalt-phosphorus/copper foam catalyst obtained by using copper foam as a substrate, then plating cobalt on the copper foam, followed by the phosphating annealing treatment (Comparative example 4) and the copper-phosphorus/cobalt foam catalyst without alkaline treatment (Comparative example 5) cannot reach the ammonia production rate and the Faraday efficiency achievable in the present disclosure, and particle aggregation occurs during stability test.

In summary, the present disclosure can prepare the copper-phosphorus/cobalt foam composite catalyst with good catalytic activity, high stability, and no aggregation. The copper-phosphorus/cobalt foam composite catalyst with excellent electrochemical activity and stability is obtained through various treatments of the cobalt foam, which can be applied to the electrocatalytic nitrate reduction reaction for ammonia synthesis, reducing the reaction kinetic potential energy of nitrate reduction for ammonia synthesis and significantly improving ammonia production efficiency.

In some embodiments, the preparation method for the copper-phosphorus/cobalt foam composite catalyst comprises the following operations.
S1: obtaining cobalt foam and pretreating the cobalt foam.
S2: obtaining a cobalt oxyhydroxide precursor with a double-layer hydroxide structure by performing alkali treatment on the pretreated cobalt foam.
S3: obtaining a copper/cobalt foam precursor by preparing a copper-plating electrolyte and subjecting the cobalt oxyhydroxide precursor to electrodeposition in the copper-plating electrolyte. The electrodeposition is performed at a constant voltage of −2 to −2.5 V vs. RHE for 100-600 s.
S4: obtaining the copper-phosphorus/cobalt foam composite catalyst by performing phosphating annealing treatment on the copper/cobalt foam precursor.

The phosphating annealing treatment is performed on the copper/cobalt foam precursor, including placing the copper/cobalt foam precursor and sodium hypophosphite powder in a tube furnace, heating to 400° C. at a rate of 1-3° C./min in an argon atmosphere, and holding for 20-30 min.

The cobalt foam is used as a substrate of the copper-phosphorus/cobalt foam composite catalyst, the substrate is covered with a coating layer including phosphorus nanoparticles and copper nanoparticles, and the phosphorus nanoparticles and the copper nanoparticles are evenly distributed on a surface of the substrate in a lamellar structure formed by nanoparticle accumulation, and a surface of the copper-phosphorus/cobalt foam composite catalyst exhibits an irregular stacked matrix morphology.

In some embodiments, in S1, the pretreating includes performing an ultrasonic cleaning treatment with a hydrochloric acid solution, anhydrous ethanol, and deionized water in sequence.

In some embodiments, in S2, the alkali treatment includes placing the pretreated cobalt foam in a sodium hydroxide solution and holding at 75-85° C. for 12-14 h.

In some embodiments, a concentration of the sodium hydroxide solution is within a range of 1-4 mol/L.

In some embodiments, in S3, the electrolyte of the copper-plating electrolyte is at least one of copper chloride, copper sulfate, and copper nitrate.

In some embodiments, a concentration of the copper-plating electrolyte is within a range of 1-4 mol/L.

In some embodiments, the copper-phosphorus/cobalt-foam composite catalyst may be prepared using the preparation method of the copper-phosphorus/cobalt-foam composite catalyst described above.

The present disclosure also provides a use of the copper-phosphorus/cobalt foam composite catalyst in nitrate reduction for ammonia synthesis.

The above contents are only representative embodiments of the present disclosure and is not a limitation of the present disclosure in any form. Any skilled person in the art may make, without departing from the scope of the technical solution of the present disclosure, slight changes or modifications to the embodiments by utilizing the technical contents disclosed above, and such embodiments shall be deemed as equivalent embodiments of this disclosure. Any simple changes, equivalent changes, and modifications made to the above embodiments based on the technical essence of this disclosure, without departing from the content of the technical solution of this disclosure, shall still fall within the scope of the technical solution of this disclosure.

What is claimed is:

1. A preparation method for a copper-phosphorus/cobalt foam composite catalyst, comprising:
S1: obtaining cobalt foam and pretreating the cobalt foam;
S2: obtaining a cobalt oxyhydroxide precursor with a double-layer hydroxide structure by performing alkali treatment on pretreated cobalt foam;
S3: obtaining a copper/cobalt foam precursor by preparing a copper-plating electrolyte and subjecting the cobalt oxyhydroxide precursor to electrodeposition in the copper-plating electrolyte; wherein the electrodeposition is performed at a constant voltage of −2 to −2.5 V vs. RHE for 100-600 s; and
S4: obtaining the copper-phosphorus/cobalt foam composite catalyst by performing phosphating annealing treatment on the copper/cobalt foam precursor;
wherein the performing phosphating annealing treatment on the copper/cobalt foam precursor includes: placing the copper/cobalt foam precursor and sodium hypophosphite powder in a tube furnace, heating to 400° C. at a rate of 1-3° C./min in an argon atmosphere, and holding for 20-30 min;
wherein the cobalt foam is used as a substrate of the copper-phosphorus/cobalt foam composite catalyst, the substrate is covered with a coating layer including phosphorus nanoparticles and copper nanoparticles, and the phosphorus nanoparticles and the copper nanoparticles are evenly distributed on a surface of the substrate in a lamellar structure formed by nanoparticle accumulation, and a surface of the copper-phosphorus/cobalt foam composite catalyst exhibits an irregular stacked matrix morphology.

2. The preparation method for the copper-phosphorus/cobalt foam composite catalyst of claim 1, wherein in S1, the pretreating includes performing ultrasonic cleaning treatment with a hydrochloric acid solution, anhydrous ethanol, and deionized water in sequence.

3. The preparation method for the copper-phosphorus/cobalt foam composite catalyst of claim 1, wherein in S2, the alkali treatment includes placing the pretreated cobalt foam in a sodium hydroxide solution and holding at 75-85° C. for 12-14 h.

4. The preparation method for the copper-phosphorus/cobalt foam composite catalyst of claim 3, wherein a concentration of the sodium hydroxide solution is within a range of 1-4 mol/L.

5. The preparation method for the copper-phosphorus/cobalt foam composite catalyst of claim 1, wherein in S3, an electrolyte of the copper-plating electrolyte is at least one of copper chloride, copper sulfate, and copper nitrate.

6. The preparation method for the copper-phosphorus/cobalt foam composite catalyst of claim 5, wherein a concentration of the copper-plating electrolyte is within a range of 1-4 mol/L.

7. A copper-phosphorus/cobalt foam composite catalyst, which is prepared by the preparation method for the copper-phosphorus/cobalt foam composite catalyst of claim 1.
